(19) United States
(12) Patent Application Publication
(10) Pub. No.: US 2008/0124265 A1
(43) Pub. Date: May 29, 2008

(54) Catalytic oxide anodes for high temperature fuel cells

(76) Inventor: Turgut M. Gur, Palo Alto, CA (US)

Correspondence Address: LUMEN PATENT FIRM, INC., 2345 YALE STREET, SECOND FLOOR, PALO ALTO, CA, 94306, US

(21) Appl. No.: 11/975,133

(22) Filed: Oct. 16, 2007

Related U.S. Application Data
(60) Provisional application No. 60/852,335, filed on Oct. 16, 2006.

(51) Int. Cl. C01G 55/00; C01F 17/00; C01G 31/00; C01G 45/00; C01G 53/00; C01G 23/00; C01G 25/00; C01G 37/00; C01G 41/00; C01G 49/00; C01G 51/00

(52) U.S. Cl. 423/263; 423/592.1; 423/593.1; 423/595; 423/594.13; 423/594.8; 423/598; 423/594.12; 423/594.1; 423/594.16; 423/599; 423/594.5; 423/594.3; 423/601; 423/594.7; 423/594.9; 423/594.14; 423/594.15

(57) ABSTRACT

An anode in a Direct Carbon Fuel Cell (DCFC) operating in a temperature range between 500 and 1200 degrees Celsius is provided. The anode material has high catalytic activity and selectivity for carbon oxidation, sufficient oxygen non-stoichiometry, rapid oxygen chemical diffusion, wide thermodynamic stability window to withstand reducing environment, sufficient electronic conductivity and tolerance to sulfur and CO₂ environments. The anode has doped ruthenate compositions A₁₋ₓA′ₓRuO₃, AB_{1-y}Ru_{y}O₃, or A₁₋ₓA′ₓB_{1-y}Ru_{y}O₃. A and A′ may be divalent, trivalent, or tetravalent cation, and B is a multivalent cation. A is among lanthanide series elements La, Ce, Pr, Nd, Sm, Eu, Gd, Dy, Er or Yb, and dopant A′ is from Group IIA, IIIB, or IVB elements. The doped ruthenates can also be a (AB_{1-y}Ru_{y}O₃) structure or an ordered Ruddlesden-Popper series ((A₁₋ₓAₓ′)ₙ₊₁(B_{1-y}Ru_{y})ₙO₃ₙ₊₁) structure where n=1 or 2. The dopant B is among Group IVB, VB, VIB, VIII, IB, and IIB elements.

### CROSS-REFERENCE TO RELATED APPLICATIONS

This application is cross-referenced to and claims the benefit from U.S. Provisional Patent Application 60/852,335 filed Oct. 16, 2006, which is hereby incorporated by reference.

### FIELD OF THE INVENTION

The invention relates to fuel cells, and, more particularly, cermet anodes for solid oxide fuel cells or a direct carbon fuel cells.

### BACKGROUND

In applications for direct carbon fuel cells (DCFC), suitable materials for catalytic anodes remain a difficult problem when considering the commercialization of these technologies. The anodes in these fuel cells are subject to harsh environments that cause degradation in the anode, thus limiting optimum operational output. It has been an ongoing effort to create anode materials that can withstand not only extreme temperatures, but also steep gradients both in chemical and electrical potentials, severely reducing atmospheres, possible coking and sulfur poisoning, and carbon at unit activity in the case of DCFC.

Because the anodes reside in a strong reducing environment in the fuel cell, it is desirable for the anode material to have high catalytic activity and selectivity for carbon oxidation, where the carbonaceous fuels are either in gas or solid form. Further, it is advantageous for the anode material to possess a broad thermodynamic stability to withstand the reducing environment.

It has been determined that the anodes require a tolerance to sulfur and CO₂ environments, where the anode must not lead to coking or be poisoned by sulfur and the heavy metals commonly present in carbonaceous fuels such as natural gas, diesel, gasoline, coal, etc. The anode must have sufficient chemical and thermal stability and compatibility, and must possess sufficient electronic conductivity to serve as a catalytic electrode.

In general, the anode material must have the ability to accommodate sufficient concentrations of point defects, i.e., large non-stoichiometry, without undergoing phase change. Non-stoichiometric compounds are chemical compounds with an elemental composition that cannot be represented by a ratio of well-defined natural numbers. Often, they are solids that contain random crystallographic point defects, resulting in the deficiency of one element. Since solids are overall electrically neutral, the missing center is compensated by a change in the charge of other atoms in the solid (either by changing the oxidation state, or by replacing it with an atom of a different element with a different charge). These changes give rise to solubility of the surface-active species in the anode material as well as facilitating fast ion transport to replenish the anode surface from the bulk. It is desirable that the anode material has sufficient oxygen non-stoichiometry and the ability to provide rapid oxygen chemical diffusion while maintaining sufficient electronic conductivity. It is also desirable for the catalytic anode to serve as a sink or reservoir for the surface-active species, which is also mobile due to the large concentration of vacancies in one of the sublattices.

A typical example is the oxidation catalysts based on bismuth molybdates that exhibit significant non-stoichiometry in the oxygen sublattice and fast chemical diffusion of oxide ions through the bulk by vacancy mechanism. These attributes collectively provide the catalyst surface from the bulk with a steady supply of lattice oxygen, the active species that is responsible for the rapid oxidation step. In this regard lattice oxygen exhibits significantly higher reactivity for oxidation reactions than molecular oxygen.

However, there is a knowledge gap, especially in the case of DCFC. Not much is known about catalytic anodes for the electrochemical oxidation of solid carbon based fuels at elevated temperatures. Cracking catalysts employed in the chemical and petrochemical industries provide limited guidance but again, the mechanism of breaking C—C bonds in a carbon or coal particle is significantly different from breaking C—H and C—C bonds in a hydrocarbon molecule. The chemical environments at the anode are sufficiently different for the cases of gaseous hydrocarbon fuels in SOFC versus solid carbonaceous fuels in DCFC. Similarly, the chemical environment of the catalyst (usually transition metals) used for coal gasification in the presence of steam is very different from the anode environment in DCFC, where only carbon oxidation to COₓ (x=1 or 2) occurs.

What is needed is an anode material having high catalytic activity and selectivity for carbon oxidation, sufficient oxygen non-stoichiometry, rapid oxygen chemical diffusion, wide thermodynamic stability window to withstand reducing environment, sufficient electronic conductivity and tolerance to sulfur and CO₂ environments.

### SUMMARY OF THE INVENTION

The current invention provides an anode in a Direct Carbon Fuel Cell (DCFC), where the anode has doped ruthenates and operates in an environment having a temperature range between 500 and 1200 degrees Celsius.

In one aspect of the invention, the ruthenate can include one of the following general compositions A₁₋ₓA′ₓRuO₃, AB_{1-y}Ru_{y}O₃, or A₁₋ₓA′ₓB_{1-y}Ru_{y}O₃ where A and A′ may be divalent, trivalent, or tetravalent cation, and B is a multivalent cation.

In another aspect of the invention, the ruthenate composition may have a range between x=0 and x=1, and/or between y=0 and y=1.

In a further aspect of the invention, A is an element chosen from the lanthanide series including La, Ce, Pr, Nd, Sm, Eu, Gd, Dy, Er, Yb, and the dopant A′ is selected from among the Group IIA, IIIB, or IVB elements including Ca, Sr, Ba, and Y.

According to one aspect of the invention, the dopant B is selected from among Group IVB, VB, VIB, VIII, IB, and IIB elements including Ti, V, Mo, Cr, Mn and Fe.

In one embodiment of the invention, the doped ruthenates can be a (AB_{1-y}Ru_{y}O₃) structure or an ordered Ruddlesden-Popper series ((A₁₋ₓAₓ′)ₙ₊₁(B_{1-y}Ru_{y})ₙO₃ₙ₊₁) structure where n=1 or 2.

In one aspect of this embodiment, the ruthenate composition may have a range between x=0 and x=1, and/or between y=0 and y=1.

In another aspect of this embodiment, the B site of the perovskite is selected from among Group IVB, VB, VIB, VIII, IB, and IIB elements including Ti, V, Nb, Mo, W, Cr, Mn and Fe, for example.

In a further aspect, the A is an element chosen from the lanthanide series including La, Ce, Pr, Nd, Sm, Eu, Gd, Dy, Er, Yb, and the dopant A′ is selected from among the Group IIA, IIIB, or IVB elements including Ca, Sr, Ba, and Y, for example.

In yet another aspect of this embodiment, the B site of the anode material doped with transition metals selected from among the elements V, Cr, Mn, Fe, Co, Ni, Rh, Cu, Zn, Ag, Pt, and Pd whereby catalytic activity, electronic conductivity and oxygen vacancy formation are enhanced.

According to one aspect of the invention, the anode does not include silicon or a silicon containing substrate.

### BRIEF DESCRIPTION OF THE FIGURES

The objectives and advantages of the present invention will be understood by reading the following detailed description in conjunction with the drawing, in which:

FIG. 1 shows a perspective view of the crystal structure of a prior art simple perovskite (ABO₃).

FIGS. 2a-2b show crystal structures of a typical Ruddlesden-Popper phase material.

### DETAILED DESCRIPTION OF THE INVENTION

Although the following detailed description contains many specifics for the purposes of illustration, anyone of ordinary skill in the art will readily appreciate that many variations and alterations to the following exemplary details are within the scope of the invention. Accordingly, the following preferred embodiment of the invention is set forth without any loss of generality to, and without imposing limitations upon, the claimed invention.

The current invention provides an anode material having high catalytic activity and selectivity for carbon oxidation, sufficient oxygen non-stoichiometry, rapid oxygen chemical diffusion, wide thermodynamic stability window to withstand reducing environment, sufficient electronic conductivity and tolerance to sulfur and CO₂ environments.

Perovskites consist of a rich family of oxides interesting properties, especially when doped properly. Many members of the perovskite family have been employed as active catalysts for a wide range of reactions including complete and partial oxidation of gaseous hydrocarbons, as well as for NOₓ reduction. Despite the rich literature on catalysis of gaseous fuels by perovskites, information about their catalytic activity and selectivity for solid carbon oxidation is rather scarce. This invention provides new anode materials with sufficient catalytic activity and suitability for direct carbon fuel cell (DCFC) applications.

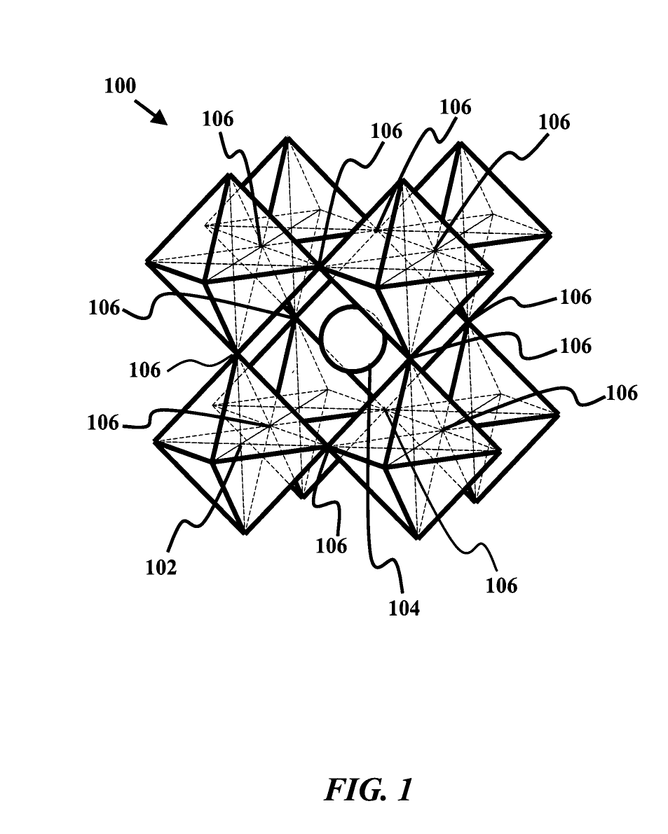

FIG. 1 shows the crystal structure of a prior art simple perovskite (ABO₃) 100. The structure is cubic and is made of eight corner-sharing BO₆ octohedra, where B 102 occupies the octahedral sites and the A ion 104 sits in a large dodecahedral interstice and is coordinated to 12 oxygen atoms 106, where in this figure only. For structural stability, it is preferred that the radii of A 104 and B 102 should be larger than 0.90 A and 0.51 A, respectively. For a given B ion, the radius of A should also satisfy the Goldschmidt condition,

0.75<(r_{A}+r_{O})/2^{1/2}(r_{B}+r_{O})<1.00

in order to optimize the ratio of the A-O and B—O bond lengths. It is generally agreed that the nature of the B atom 102 governs much of the catalytic and physical properties of the perovskite structure.

This remarkable flexibility in selecting the Aⁿ⁺ and B^{m+} ions in ABO₃ (where valence states n+m=6 for charge neutrality) and the ability to further dope these sites with appropriate cations form the basis for the unusually diverse structures and properties offered by this rich family of oxides. Specifically, the composition ABO₃ can be varied widely by A-site, B-site or A,B-site doping in the form of solid solutions of the general compositions A₁₋ₓA′ₓBO₃, AB_{1-y}B′_{y}O₃, or A₁₋ₓA′ₓB_{1-y}B′_{y}O₃. Triplicate doping of these sites are also possible, opening wider opportunities to tune for desired properties.

One embodiment of the current invention provides an anode, having doped ruthenates, in a Direct Carbon Fuel Cell (DCFC) (not shown) that operates at a temperature range between 500 and 1200 degrees Celsius. The ruthenates have general compositions A₁₋ₓA′ₓRuO₃, AB_{1-y}Ru_{y}O₃, or A₁₋ₓA′ₓB_{1-y}Ru_{y}O₃ where A and A′ may be divalent, trivalent, or tetravalent cation, and B is a multivalent cation. According to the invention, the ruthenate composition has a range between x=0 and x=1, and/or between y=0 and y=1. Here, A is an element chosen from the lanthanide series including La, Ce, Pr, Nd, Sm, Eu, Gd, Dy, Er, Yb, and the dopant A′ is selected from among the Group IIA, IIIB, or IVB elements including Ca, Sr, Ba, and Y. Further, the dopant B is selected from among Group IVB, VB, VIB, VIII, IB, and IIB elements including Ti, V, Mo, Cr, Mn and Fe, for example.

In another aspect, the basic ABO₃ structure when ordered, gives the Ruddlesden-Popper (RP) series (not shown) of compounds with the general formula Aₙ₊₁BₙO₃ₙ₊₁ (n is typically 1 or 2), which consists of n octahedral layers of perovskite-like AₙBₙO₃ₙ blocks separated by a rock-salt layer of AO. At the limit when n is large, the ordered RP phase adopts the cubic ABO₃ perovskite structure. Thus, the RP phases also offer a rich opportunity to modify properties by doping.

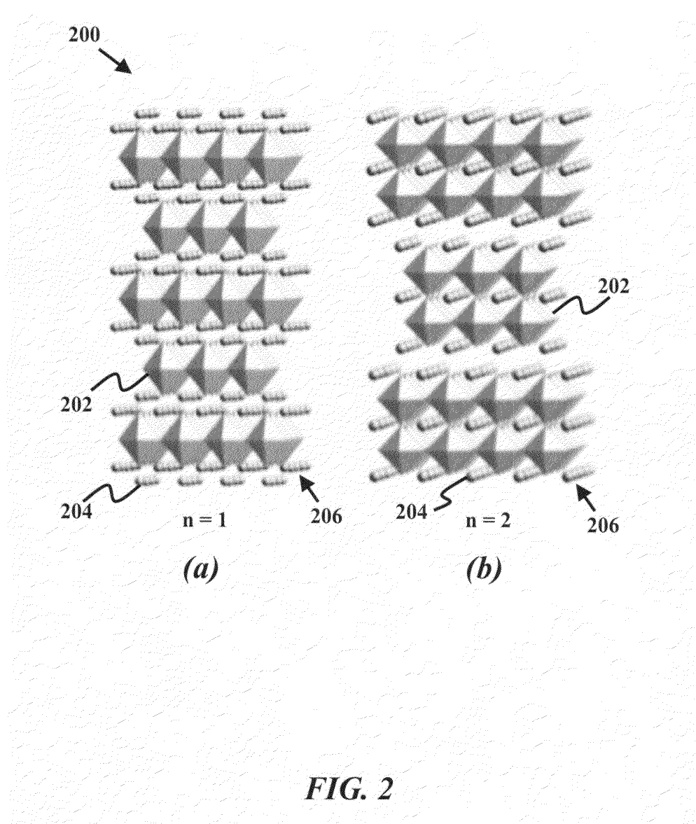

FIGS. 2a and 2b show crystal structures of a typical Ruddlesden-Popper phase material 200. Shown is the crystal structure for Srₙ₊₁MnₙO3ₙ₊₁ corresponding to compositions for n=1 (FIG. 2a) and n=2 (FIG. 2b) that show the MnO₆ octahedra 202 and the Sr atoms 204 lined along the tunnels 206.

One embodiment of the current invention provides ruthenates and their doped variations or ordered RP phases as anode materials for carbon oxidation in Direct Carbon Fuel Cells DCFCs (not shown). Surprisingly, SrRuO₃ is the only known ferromagnetic metal among the 4d oxides. In 4d as well as the 3d oxides, it is well understood that the d electrons are primarily responsible for their transport and catalytic properties. Indeed, ruthenium (Kr4d⁷5s¹) either in pure or Pt/Ru bimetallic form, or as a dopant in perovskites is widely explored as catalysts for water gas shift reaction and reduction of NOₓ by CO, as well as electrodes for direct methanol (DMFC) and PEM fuel cells.

At elevated temperatures, binary oxides of ruthenium, namely RuO₂ and RuO₃ are volatile and may be unsuitable for DCFC application. However, incorporation of Ru into the perovskite lattice stabilizes it and prevents its volatilization. Hence, ruthenates have improved stability at elevated temperatures

Chemical and thermal stability of these doped ruthenate structures under reducing conditions are critical for DCFC applications. At 1000° C. and under reducing atmospheres, the stability limits, in terms of the critical oxygen partial pressure-log P_{O2} (bar) for various perovskites, are greater than 21.1 for LaCrO₃ and LaVO₃, 16.95 for LaFeO₃, and 15.05 for LaMnO₃. Hence, Cr and V based perovskite structures have sufficient stability for DCFC applications while for Fe and Mn, their stability may be borderline.

Other perovskites and related structures that are based on Mo, W, Ta, Ti, Nb, and V sitting at the B-site are also suitable for anode materials, and are also covered under this invention. The A-site ion may be chosen from Group II, IIIB, and IVB elements. Moreover, both the A- and B-sites can further be doped with transition metals to enhance catalytic activity, electronic conductivity, and oxygen vacancy formation.

According to one embodiment of the invention, the doped ruthenates can be a (AB_{1-y}Ru_{y}O₃) structure or the ordered Ruddlesden-Popper series ((A₁₋ₓAₓ′)ₙ₊₁(B_{1-y}Ru_{y})ₙO₃ₙ₊₁) structure where n=1 or 2. In such, the ruthenate composition may have a range between x=0 and x=1, and/or between y=0 and y=1. Further, the B site of the perovskite is selected from among Group IVB, VB, VIB, VIII, IB, and IIB elements including Ti, V, Nb, Mo, W, Cr, Mn and Fe, for example. In the current embodiment, the A is an element chosen from the lanthanide series including La, Ce, Pr, Nd, Sm, Eu, Gd, Dy, Er, Yb, and the dopant A′ is selected from among the Group IIA, IIIB, or IVB elements including Ca, Sr, Ba, and Y, for example. Additionally, the B site of the anode material doped with transition metals can be selected from among the elements V, Cr, Mn, Fe, Co, Ni, Rh, Cu, Zn, Ag, Pt, and Pd whereby catalytic activity, electronic conductivity and oxygen vacancy formation are enhanced.

One key aspect of the current invention is the anode does not include silicon or a silicon containing substrate.

The present invention has now been described in accordance with several exemplary embodiments, which are intended to be illustrative in all aspects, rather than restrictive. Thus, the present invention is capable of many variations in detailed implementation, which may be derived from the description contained herein by a person of ordinary skill in the art. All such variations are considered to be within the scope and spirit of the present invention as defined by the following claims and their legal equivalents.

What is claimed:

1. An anode in a Direct Carbon Fuel Cell (DCFC), wherein said anode comprises doped ruthenates, whereby said anode operates in an environment having a temperature range between 500 and 1200 degrees Celsius.

2. The anode of claim 1, wherein said ruthenate is selected from a group of general compositions consisting of A₁₋ₓA′ₓRuO₃, AB_{1-y}Ru_{y}O₃, and A₁₋ₓA′ₓB_{1-y}Ru_{y}O₃ whereas said A and said A′ are selected from a cation group consisting of divalent, trivalent, and tetravalent, whereby B is a multivalent cation.

3. The anode of claim 2, wherein said ruthenate composition comprises a range between x=0 and x=1, and/or between y=0 and y=1.

4. The anode of claim 2, wherein said A is an element chosen from the lanthanide series comprising La, Ce, Pr, Nd, Sm, Eu, Gd, Dy, Er, Yb, and said dopant A′ is selected from a group consisting of Group IIA elements and Group IIIB elements, Group IVB elements.

5. The anode of claim 2, wherein said B is a dopant selected a group consisting of Group IVB elements, Group VB elements, Group VIB elements, Group VIII elements, Group IB elements, Group IIB elements, Mn and Fe.

6. The anode of claim 1, wherein said doped ruthenates comprise a (AB_{1-y}Ru_{y}O₃) structure or an ordered Ruddlesden-Popper series ((A₁₋ₓAₓ′)ₙ₊₁(B_{1-y}Ru_{y})ₙO₃ₙ₊₁) structure where n=1 or 2.

7. The anode of claim 6, wherein said ruthenate composition comprises a range between x=0 and x=1, and/or between y=0 and y=1.

8. The anode of claim 6, wherein said B is selected from a group consisting of Group IVB elements, Group VB elements, Group VIB elements, Group VIII elements, Group IB elements, Group IIB elements, Mn and Fe.

9. The anode of claim 6, wherein said A is selected from a group consisting of La, Ce, Pr, Nd, Sm, Eu, Gd, Dy, Er, and Yb, whereas said A′ is selected from a group consisting of Group IIA elements, Group IIIB elements and Group IVB elements.

10. The anode of claim 6, wherein said B is selected from a group consisting of V, Cr, Mn, Fe, Co, Ni, Rh, Cu, Zn, Ag, Pt, and Pd.

11. The anode of claim 1, wherein said anode does not comprise silicon or a silicon containing substrate.
